(19) United States
(12) Patent Application Publication
(10) Pub. No.: US 2025/0096620 A1
(43) Pub. Date: Mar. 20, 2025

(54) WIRELESS CHARGING MODULE LOCATING DEVICE

(71) Applicant: GM Global Technology Operations LLC, Detroit, MI (US)

(72) Inventor: Brian Russell Wachter, Grosse Pointe Park, MI (US)

(73) Assignee: GM Global Technology Operations LLC, Detroit, MI (US)

(21) Appl. No.: 18/469,464

(22) Filed: Sep. 18, 2023

(51) Int. Cl. H02J 50/90; B60R 16/03

(52) U.S. Cl. CPC H02J 50/90; B60R 16/03

(57) ABSTRACT

A wireless charging system for charging a mobile device arranged within a passenger compartment area of a motor vehicle includes a wireless charging module providing a wireless charging area having a charging zone. The wireless charging system further includes a charging device positioning system disposed adjacent to the wireless charging module and configured to bias the mobile device into the charging zone.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to vehicular interior trim components and more particularly to wireless device charging systems incorporated into a vehicular interior trim component.

Vehicular interior trim components provide an aesthetically pleasing appearance to the passenger compartment area of a vehicle. In some instances, vehicular interior trim components may also provide a function that vehicle users may exploit when the vehicle is being driven or, alternatively, when the vehicle is arranged in a parked state. Furthermore, original equipment manufacturers (OEMs) continue to seek to improve the experience of a passenger that resides in the passenger compartment area of a vehicle, which may include, for example, maintaining a sufficient amount of energy in one or more mobile devices that consume electricity.

### SUMMARY

An aspect of the disclosure provides a wireless charging system for charging a mobile device arranged within a passenger compartment area of a motor vehicle. The wireless charging system includes a wireless charging module providing a wireless charging area having a charging zone. The wireless charging system further includes a charging device positioning system disposed adjacent to the wireless charging module and configured to bias the mobile device into the charging zone.

Aspects of the disclosure may include one or more of the following optional features. In some examples, the wireless charging module is integrated into an interior panel of the passenger compartment area of the motor vehicle. In some examples, the charging device positioning system includes a longitudinal positioning system configured to bias the mobile device into the charging zone along a longitudinal axis of the motor vehicle. In some examples, the system includes a lateral positioning system configured to bias the mobile device into the charging zone along a lateral axis of the motor vehicle.

In some implementations, at least one of the longitudinal positioning system and the lateral positioning system includes at least one biasing element configured to retract within the interior panel of the passenger compartment area of the motor vehicle. In some implementations, the at least one biasing element may include a pair of longitudinal biasing elements of the longitudinal positioning system and a pair of lateral biasing elements of the lateral positioning system. In some configurations, the pair of longitudinal biasing elements of the longitudinal positioning system are configured to move relative to the pair of lateral biasing elements of the lateral positioning system.

In some examples, each biasing element of the pair of longitudinal biasing elements of the longitudinal positioning system and each biasing element of the pair of lateral biasing elements of the lateral positioning system may be configured to be biased to the charging zone by a spring. In some implementations, each biasing element of the pair of longitudinal biasing elements of the longitudinal positioning system and each biasing element of the pair of lateral biasing elements of the lateral positioning system may be configured to be biased to the charging zone by a motor. In some examples, each biasing element of the pair of longitudinal biasing elements of the longitudinal positioning system and each biasing element of the pair of lateral biasing elements of the lateral positioning system is configured to be biased to the charging zone by a motor.

In some implementations, the motor is in communication with a charging system controller having data processing hardware and memory hardware storing instructions that, when executed by the data processing hardware, cause the data processing hardware to perform operations including receiving a charging device identifier, determining an optimized configuration for the charging device positioning system based on the charging device identifier, and moving the charging device positioning system to the optimized configuration to maximize a charging rate of the mobile device. In some examples, the motor is in communication with a charging system controller having data processing hardware and memory hardware storing instructions that, when executed by the data processing hardware, cause the data processing hardware to perform operations including receiving charging rate feedback from the wireless charging module indicating a current charging rate for a charging, determining whether the current charge rate satisfies a charge rate threshold, and when the current charging rate does not satisfy a charge rate threshold, instructing the charging device positioning system to move to an optimized configuration to maximize the current charging rate.

Another aspect of the disclosure provides a wireless charging system for charging a mobile device arranged within a passenger compartment area of a motor vehicle, the wireless charging system includes a wireless charging module providing a wireless charging area having a charging zone and a charging device positioning system disposed adjacent to the wireless charging module and configured to bias the mobile device into the charging zone.

Aspects of the disclosure may include one or more of the following optional features. In some configurations, the wireless charging system includes the wireless charging module integrated into an interior panel of the passenger compartment area of the motor vehicle. In some implementations, the charging device positioning system includes a longitudinal positioning system configured to bias the mobile device into the charging zone along a longitudinal axis of the motor vehicle. In these implementations, the charging device positioning system may include a lateral positioning system configured to bias the mobile device into the charging zone along a lateral axis of the motor vehicle. In some examples, at least one of the longitudinal positioning system and the lateral positioning system includes at least one biasing element configured to retract within the interior panel of the passenger compartment area of the motor vehicle. The wireless charging system may include at least one biasing element, may include a pair of longitudinal biasing elements of the longitudinal positioning system, and/or a pair of lateral biasing elements of the lateral positioning system.

In some configurations, the pair of longitudinal biasing elements of the longitudinal positioning system are configured to move relative to the pair of lateral biasing elements of the lateral positioning system. In some examples, each biasing element of the pair of longitudinal biasing elements of the longitudinal positioning system and each biasing element of the pair of lateral biasing elements of the lateral positioning system may be configured to be biased to the charging zone by a spring. Each biasing element of the pair of longitudinal biasing elements of the longitudinal positioning system and each biasing element of the pair of lateral biasing elements of the lateral positioning system may be configured to be biased to the charging zone by a motor.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1A is a top perspective view of a mobile device arranged proximate, but not interfaced with, an interior trim component having a wireless charging zone in accordance with the principles of the present disclosure:

FIG. 1B is top perspective view according to FIG. 1A showing the mobile device interfaced with the interior trim component in a non-optimized position with respect to the wireless charging zone:

FIG. 1C is top perspective view according to FIG. 1B showing the mobile device interfaced with the interior trim component in an optimized position with respect to the wireless charging zone; and

FIG. 2 is a side view of the mobile device of FIG. 1A and a side schematic view of a portion of the interior trim component of FIG. 1C.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on.” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on.” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first.” “second.” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below; the term module may be replaced with the term circuit. The term module may refer to, be part of, or include an Application Specific Integrated Circuit (ASIC): a digital, analog, or mixed analog/digital discrete circuit: a digital, analog, or mixed analog/digital integrated circuit: a combinational logic circuit: a field programmable gate array (FPGA): a processor (shared, dedicated, or group) that executes code; memory (shared, dedicated, or group) that stores code executed by a processor: other suitable hardware components that provide the described functionality: or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app.” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory. Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data. e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices: magnetic disks, e.g., internal hard disks or removable disks: magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well: for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's client device in response to requests received from the web browser.

The present disclosure relates generally to vehicular interior trim components and more particularly to vehicular interior trim components arranged in a passenger compartment area of a vehicle. In some implementations, the vehicular interior trim component is an armrest, a lid of an armrest, a center console, a floor console, or the like. In other implementations, the vehicular trim component may include other areas of the vehicle cockpit, such as in an instrument panel, on a dashboard, or below a steering wheel. Such areas provide one or more storage cavities configured to contain one or more items that a vehicle occupant may store or retrieve therefrom at any time before, during, or after use of the vehicle. In some instances, the one or more items may include, for example, a mobile device that consumes electricity (e.g., a mobile phone, a tablet computer, or the like). Accordingly, the vehicular interior trim component is configured to include a wireless charging system having a wireless charging bed defining a wireless charging area including an optimized charging zone. A mobile device positioning system is disposed adjacent the wireless charging bed and is configured to bias the mobile device from a first position that is not within the optimized charging zone to a second position that is within the optimized charging zone. Once arranged within the optimized charging zone, the mobile device may be electrically coupled to the wireless charging bed in order to accumulate and store energy in order to permit operation of the mobile device.

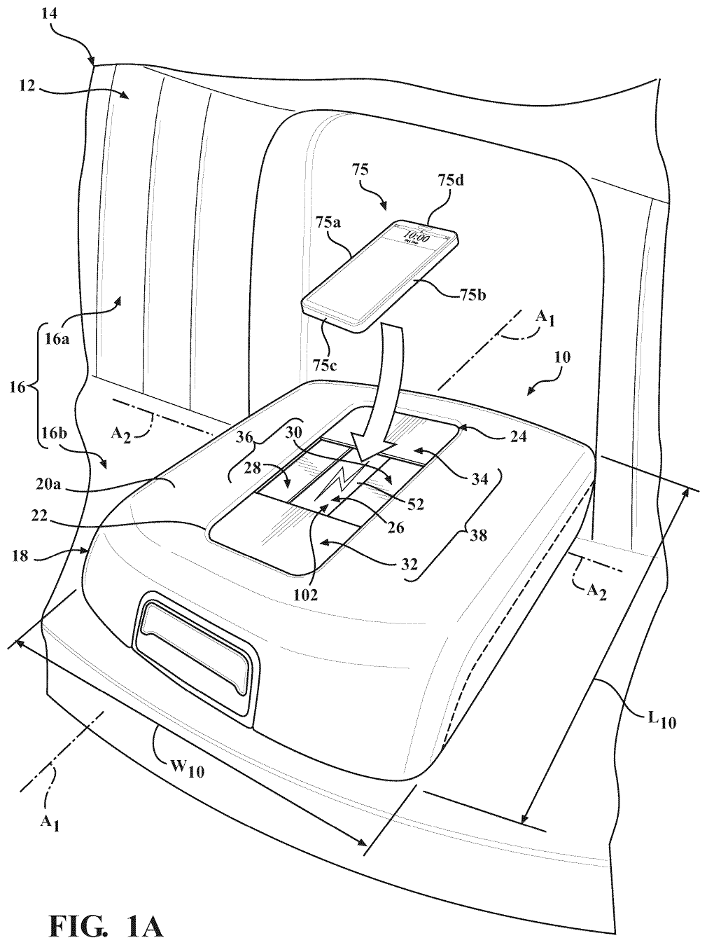

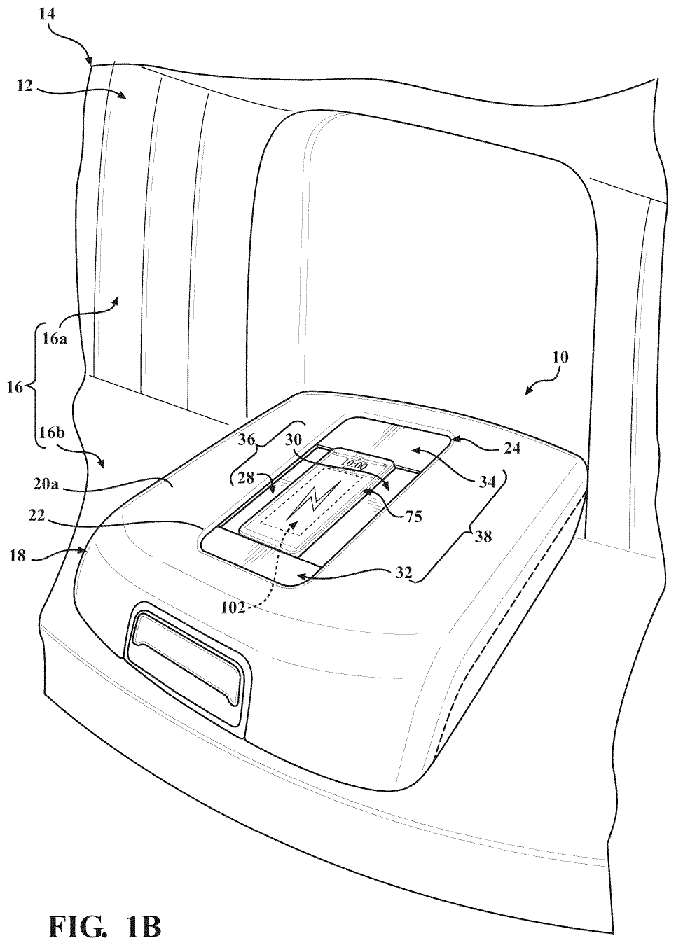

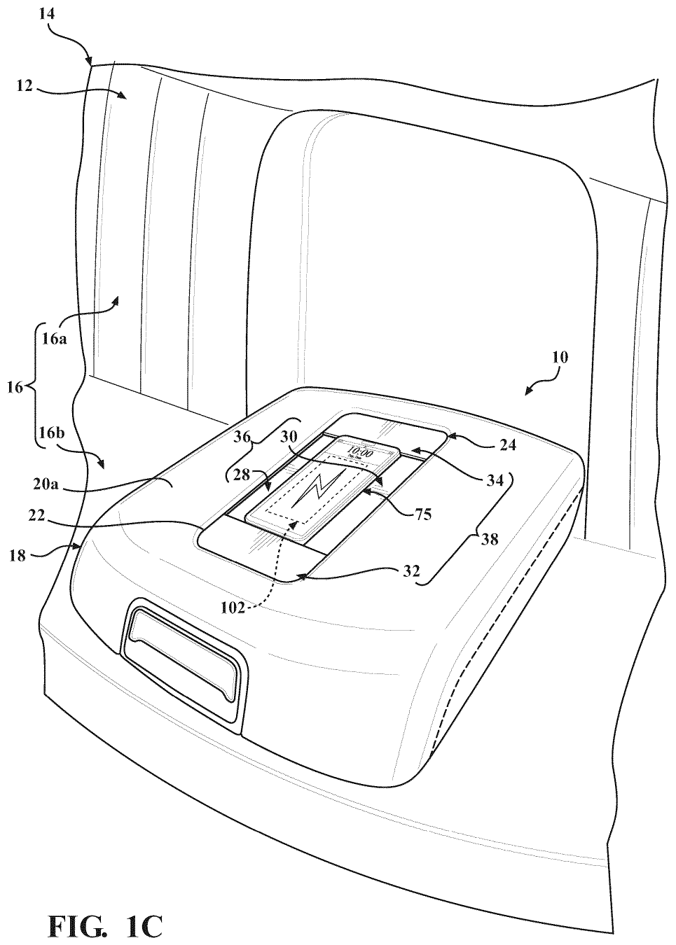

Referring to FIGS. 1A-1C, a vehicular interior trim component 10 is shown in accordance with an implementation of the present disclosure. In some configurations, the vehicular interior trim component 10 is configured as a vehicular passenger compartment panel. In other configurations, the vehicular interior trim component 10 is configured as an armrest, a lid of an armrest, a center console, a door console, a floor console, or the like. The vehicular interior trim component 10 may be formed including any desirable material or combination thereof (e.g., plastics, foams, or the like) and may be formed in any desirable process (e.g., injection molding, blow molding, vacuum molding, or the like).

The vehicular interior trim component 10 is arranged within a passenger compartment area 12 of a vehicle 14. As seen at FIGS. 1A-1C, the vehicular interior trim component 10 may be configured as an armrest that is deployable from a stowed orientation (not shown) within or adjacent a back portion 16a of a bench-style seat 16 to a deployed orientation adjacent a seat portion 16b of the bench-style seat 16. Once arranged in the deployed orientation at FIGS. 1A-1C, a length L₁₀ (see, e.g., FIG. 1A) of the vehicular interior trim component 10 may be arranged along a longitudinal axis A1-A1 (see, e.g., FIG. 1A) of the vehicle 14. Furthermore, as also seen at FIGS. 1A-1C, once arranged in the deployed orientation at FIGS. 1A-1C, a width W₁₀ (see, e.g., FIG. 1A) of the vehicular interior trim component 10 may be arranged along a cross-car or lateral axis A2-A2 (see, e.g., FIG. 1A) of the vehicle 14.

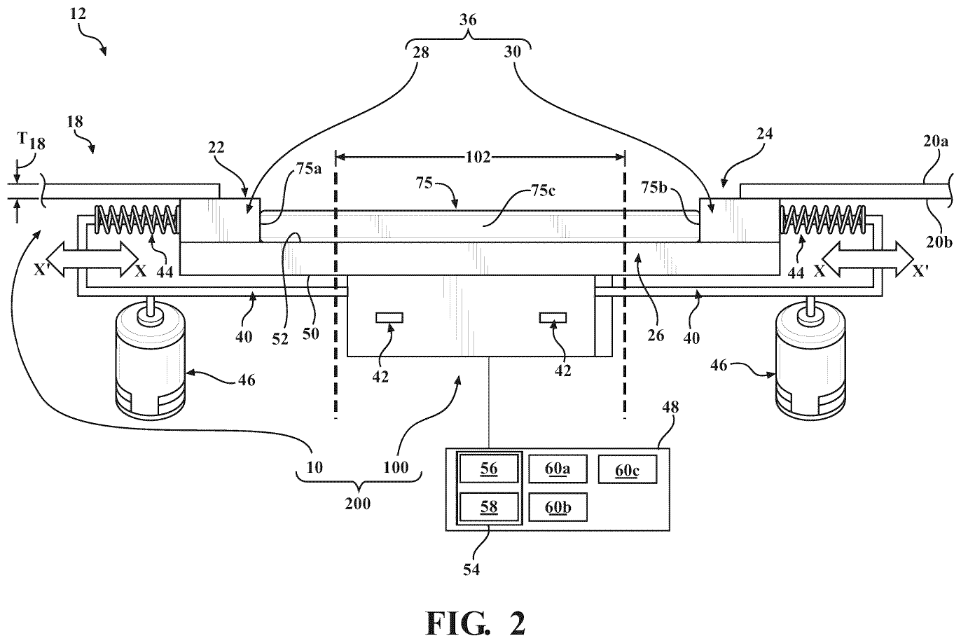

Referring initially to FIG. 1A, the vehicular interior trim component 10 includes a body portion 18 having a top surface 20a. The body portion 18 also defines a passage 22 extending at least partially through a thickness T₁₈ (see, e.g., FIG. 2) of the body portion 18. The thickness T₁₈ extends between the top surface 20a of the body portion 18 and the bottom surface 20b (see, e.g., FIG. 2) of the body portion 18.

The vehicular interior trim component 10 also includes a charging device positioning system 24. The charging device positioning system 24 is aligned with and closes out the passage 22 formed by the body portion 18. Furthermore, with reference to FIG. 2, the charging device positioning system 24 is recessed from the top surface 20a of the body portion 18. Yet even further, the charging device positioning system 24 is indirectly connected to, directly connected to, or otherwise supported by the body portion 18. While the illustrated example shows the charging device positioning system 24 being recessed from the top surface 20a, other implementations may present the charging device positioning system flush with or proud of the top surface 20a.

As seen at FIGS. 1A-1C, the charging device positioning system 24 includes a plurality of panels 26-34. A first panel 26 (see also, e.g., FIG. 1A) of the plurality of panels 26-34 is a charging panel 26 of the charging device positioning system 24. As will be described in the following disclosure, the charging panel 26 is configured to support a rear surface of a mobile device 75. The front surface of the mobile device has a touch screen (see, e.g., FIGS. 1A-1C) for interaction with a user. The rear surface of the mobile device has a wireless charging interface (not shown).

A second panel 28 (see, e.g., FIGS. 1A-1C and 2) of the plurality of panels 26-34 is a movable first lateral positioning panel 28 of the charging device positioning system 24. As will be described in the following disclosure, the movable first lateral positioning panel 28 is configured to selectively laterally engage a first lateral edge 75a (see, e.g., FIGS. 1A and 2) of the mobile device 75.

A third panel 30 (see, e.g., FIGS. 1A-1C and 2) of the plurality of panels 26-34 is a movable second lateral positioning panel 30 of the charging device positioning system 24. As will be described in the following disclosure, the movable second lateral positioning panel 30 is configured to selectively laterally engage a second lateral edge 75b (see, e.g., FIGS. 1A and 2) of the mobile device 75. The movable second lateral positioning panel 30 is arranged opposite the movable first lateral positioning panel 28. Accordingly, the second lateral edge 75b of the mobile device 75 is opposite the first lateral edge 75a of the mobile device 75.

A fourth panel 32 (see, e.g., FIGS. 1A-1C) of the plurality of panels 26-34 is a movable first longitudinal positioning panel 32 of the charging device positioning system 24. As will be described in the following disclosure, the movable first longitudinal positioning panel 32 is configured to selectively laterally engage a first longitudinal edge 75c (see, e.g., FIG. 1A) of the mobile device 75.

A fifth panel 34 of the plurality of panels 26-34 is a movable second longitudinal positioning panel 34 of the charging device positioning system 24. As will be described in the following disclosure, the movable second longitudinal positioning panel 34 is configured to selectively laterally engage a second longitudinal edge 75d (see, e.g., FIG. 1A) of the mobile device 75. The movable second longitudinal positioning panel 34 is arranged opposite the movable first longitudinal positioning panel 32: accordingly, the second longitudinal edge 75d of the mobile device 75 is opposite the first longitudinal edge 75c of the mobile device 75.

The movable first lateral positioning panel 28 and the movable second lateral positioning panel 30 cooperate to define a lateral positioning system 36 of the charging device positioning system 24. As will be described in the following disclosure at FIG. 1B, the lateral positioning system 36 of the charging device positioning system 24 biases, along the lateral axis A2-A2 (FIG. 1A) of the vehicle 14, a lateral orientation of the mobile device 75 upon the charging panel 26 of the charging device positioning system 24.

Similarly, the movable first longitudinal positioning panel 32 and the movable second longitudinal positioning panel 34 cooperate to define a longitudinal positioning system 38 of the charging device positioning system 24. As will be described in the following disclosure at FIG. 1C, the longitudinal positioning system 38 of the charging device positioning system 24 biases, along the longitudinal axis A1-A1 (FIG. 1A) of the vehicle 14, a longitudinal orientation of the mobile device 75 upon the charging panel 26 of the charging device positioning system 24.

Referring to FIG. 2, the charging device positioning system 24 also includes one or more lateral guide tracks 40, one or more longitudinal guide tracks 42, one or more springs 44, and, optionally, one or more motors 46. In some configurations, if the charging device positioning system 24 includes one or more springs 44, but not one or more motors 46, the charging device positioning system 24 may be referred to as a mechanically controlled device. In other configurations, if the charging device positioning system 24 includes one or more motors 46, but not one or more springs 44, the charging device positioning system 24 may be referred to as an electronically controlled device. The springs 44 and/or motors 46 may be collectively referred to as actuators 44, 46.

As seen at FIG. 2, each movable positioning panel 28, 30 of the lateral positioning system 36 is supported by and connected to the lateral guide tracks 40. Similarly, each movable positioning panel 32, 34 (not shown at FIG. 2) of the longitudinal positioning system 38 is supported by and connected to the longitudinal guide tracks 42.

With continued reference to FIG. 2, the movable positioning panels 28-34 of the lateral positioning system 36 and the longitudinal positioning system 38 may be moved in a first clamping direction X within the lateral guide tracks 40 or the longitudinal guide tracks 42 in response to a deploying force imparted by the one or more springs 44 and/or the one or more motors 46. Conversely, the movable positioning panels 28-34 of the lateral positioning system 36 and the longitudinal positioning system 38 may be moved in a second unclamping direction X′ (that is opposite the first clamping direction X) within the lateral guide tracks 40 or the longitudinal guide tracks 42 in response to a retracting force imparted by the one or more springs 44 and/or the one or more motors 46.

As also seen at FIG. 2, the charging device positioning system 24 also includes a control system 48. The control system 48 is in communication with the motors 46. The control system 48 may include a controller 54 having data processing hardware 56 and associated memory hardware 58, and one or more inputs 60, 60a-60c. Examples of the one or more inputs 60, 60a-60c may include a push button or user interface 60a, a presence or proximity sensor 60b, a microphone 60c, or the like.

In some examples, a passenger in the passenger compartment area 12 may interface with the user interface 60a of the control system 48 in order to cause movement of the movable positioning panels 28-34 in the first clamping direction X or the second unclamping direction X′. In another example, a passenger in the passenger compartment area 12 may arrange his/her hand and/or the mobile device 75 near the proximity sensor 60b in order to cause movement of the movable positioning panels 28-34 in the first clamping direction X or the second unclamping direction X′. Alternatively, the charging device positioning system 24 may include a sensor for detecting the presence of the mobile device 75 in the charging device positioning system 24 to automatically actuate the positioning panels 28-34. In yet another example, a passenger in the passenger compartment area 12 may issue a voice command that is received by the microphone 60c and transmitted to the controller 48, which executes corresponding instructions to translate the movable positioning panels 28-34 in the first clamping direction X or the second unclamping direction X′. In some examples, the charging device positioning system 24 may send a presence signal to the controller 48 to generate a prompt or notification when the mobile device 75 is present in the charging device positioning system 24 upon occupant exit from the vehicle.

As seen at FIGS. 1A-1C, the movable lateral positioning panels 28, 30 of the lateral positioning system 36 are arranged under the movable longitudinal positioning panels 32, 34 of the longitudinal positioning system 38 in an overlapping or telescoping arrangement. Accordingly, while the movable lateral positioning panels 28, 30 of the lateral positioning system 36 are permitted to move relative to the movable longitudinal positioning panels 32, 34 of the longitudinal positioning system 38, the arrangement of the movable positioning panels 28-34 results in the movable longitudinal positioning panels 32, 34 of the longitudinal positioning system 38 covering or otherwise at least partially obscuring the movable lateral positioning panels 28, 30 of the lateral positioning system 36.

Referring to FIG. 2, a wireless charging module 100 is shown in accordance with an implementation of the present disclosure. Collectively, the wireless charging module 100 and the vehicular interior trim component 10 that includes the charging device positioning system 24 define a wireless charging system 200.

The wireless charging module 100 is arranged below, indirectly connected to, directly connected to, or otherwise supported by a lower surface 50 of the charging panel 26 of the charging device positioning system 24. The wireless charging module 100 is arranged relative the charging panel 26 of the charging device positioning system 24 in order to permit wireless (e.g., inductive) charging of the mobile device 75 when the mobile device 75 is arranged upon an upper surface 52 (see also FIG. 1A) of the charging panel 26 of the charging device positioning system 24.

Referring to FIG. 2, the wireless charging module 100 generally defines a charging zone 102 (see also FIGS. 1A-1C). The charging zone 102 extends across some, but not all, of the charging panel 26 of the charging device positioning system 24. Accordingly, as seen at FIGS. 1A-1B, after a passenger in the passenger compartment area 12 arranges the mobile device 75 upon the upper surface 52 of the charging panel 26 of the charging device positioning system 24, the mobile device 75 may not be sufficiently arranged within the charging zone 102 in order to permit the wireless charging module 100 to charge the mobile device 75. An misalignment of the mobile device 75 within the charging zone 102 may be alternatively referred to as the mobile device 75 not being centered in the charging zone 102, or, alternatively, the mobile device 75 not being arranged in an optimized position relative to the charging zone 102 such that the mobile device 75 may not be arranged to permit or initiate wireless charging by the wireless charging module 100.

Referring to FIG. 1A, after a passenger in the passenger compartment area 12 arranges the mobile device 75 upon the upper surface 52 of the charging panel 26 of the charging device positioning system 24, the passenger in the passenger compartment area 12 may then actuate the one or more actuators 44, 46. Actuation of the one or more actuators 44, 46 imparts movement X/X′ of the movable lateral positioning panels 28, 30 of the lateral positioning system 36 and the movable longitudinal positioning panels 32, 34 of the longitudinal positioning system 38.

As seen at FIG. 1B, in a first step, responsive to actuation of the one or more actuators 44, 46, the movable lateral positioning panels 28, 30 of the lateral positioning system 36 respectively engage the first lateral edge 75a of the mobile device 75 and a second lateral edge 75b of the mobile device 75. Lateral engagement of the mobile device 75, as described above, results in lateral positioning of the mobile device 75 along the lateral axis A2-A2 of the vehicle 14, whereby the mobile device 75 is laterally aligned relative to the charging zone 102.

Although the mobile device 75 may be laterally aligned relative the charging zone 102, the mobile device 75 may not yet be longitudinally aligned relative the charging zone 102. Accordingly, thereafter, as seen at FIG. 1C, in a second step, the movable longitudinal positioning panels 32, 34 of the longitudinal positioning system 38 respectively engage a first longitudinal edge 75c of the mobile device 75 and a second longitudinal edge 75d of the mobile device 75. Longitudinal engagement of the mobile device 75 as described above results in longitudinal positioning of the mobile device 75 along the longitudinal axis A1-A1 of the vehicle 14, whereby the mobile device 75 is longitudinally aligned relative the charging zone 102. After both of the lateral positioning system 36 and the longitudinal positioning system 38 respectively laterally and longitudinally position the mobile device 75 as described above, the mobile device 75 is aligned with the charging zone 102 as seen at FIG. 1C. In this position, the mobile device 75 is centered or arranged for optimized charging within the charging zone 102 in order to permit or initiate wireless charging by the wireless charging module 100.

In some instances, the controller 54 includes a processor 56 connected to one or more motors 46. The processor 56 may be coupled to memory hardware 58 that stores a program with instructions for movement X/X′ of the movable positioning panels 28-34, whereby the movable positioning panels 28-34 may move in a predetermined manner in order to accommodate one or more mobile devices 75 that have different sizes. Accordingly, in some implementations, the controller 54 may receive an identifier, either from the passenger or directly from the mobile device 75 (e.g., via wired or wireless communication protocol) that is associated with a particular mobile device 75. Thereafter, the one or more motors 46 imparts movement X/X′ to the movable positioning panels 28-34 that results in the mobile device 75 being moved into a centered or optimized position within the charging zone 102, as described above. Then, after the mobile device 75 is moved into the charging zone 102, the passenger may save in the memory hardware 58 the identifier associated with the mobile device 75 and the imparted movement X/X′ to the movable positioning panels 28-34 that results in the mobile device 75 being moved into the centered or optimized position within the charging zone 102.

Yet even further, in some examples, the controller 54 may be connected to and receive charging rate feedback from the wireless charging module 100. The charging feedback rate indicates a current charging rate for a charging session of the mobile device 75. The processor 48 may determine whether the current charge rate satisfies a threshold charge rate (e.g., during the course of movement of the vehicle 14, the mobile device 75 may have inadvertently shifted away from the charging zone 102). The controller 54 may then determine that when the current charging rate does not satisfy the threshold charge rate, the processor 56 may instruct the user interface 60a or another indicator to generate a signal to a passenger in the passenger compartment area to reposition or return the mobile device 75 to the centered or optimized position within the charging zone 102 in order to maximize the current charging rate. Alternatively, the processor 56 may instruct the wireless charging module 100 to reposition the mobile device 75 on the charging panel 26.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A wireless charging system for charging a mobile device arranged within a passenger compartment area of a motor vehicle, the wireless charging system comprising:
a wireless charging module providing a wireless charging area having a charging zone; and
a charging device positioning system disposed adjacent to the wireless charging module and configured to bias the mobile device into the charging zone.

2. The wireless charging system of claim 1, wherein the wireless charging module is integrated into an interior panel of the passenger compartment area of the motor vehicle.

3. The wireless charging system of claim 2, wherein the charging device positioning system includes a longitudinal positioning system configured to bias the mobile device into the charging zone along a longitudinal axis of the motor vehicle.

4. The wireless charging system of claim 3, wherein the charging device positioning system includes a lateral positioning system configured to bias the mobile device into the charging zone along a lateral axis of the motor vehicle.

5. The wireless charging system of claim 4, wherein at least one of the longitudinal positioning system and the lateral positioning system includes at least one biasing element configured to retract within the interior panel of the passenger compartment area of the motor vehicle.

6. The wireless charging system of claim 5, wherein the at least one biasing element includes:
a pair of longitudinal biasing elements of the longitudinal positioning system; and
a pair of lateral biasing elements of the lateral positioning system.

7. The wireless charging system of claim 6, wherein the pair of longitudinal biasing elements of the longitudinal positioning system are configured to move relative to the pair of lateral biasing elements of the lateral positioning system.

8. The wireless charging system of claim 7, wherein each biasing element of the pair of longitudinal biasing elements of the longitudinal positioning system and each biasing element of the pair of lateral biasing elements of the lateral positioning system is configured to be biased to the charging zone by a spring.

9. The wireless charging system of claim 7, wherein each biasing element of the pair of longitudinal biasing elements of the longitudinal positioning system and each biasing element of the pair of lateral biasing elements of the lateral positioning system is configured to be biased to the charging zone by a motor.

10. The wireless charging system of claim 9, wherein the motor is in communication with a charging system controller having data processing hardware and memory hardware storing instructions that, when executed by the data processing hardware, cause the data processing hardware to perform operations comprising:
receiving a charging device identifier;
determining an optimized configuration for the charging device positioning system based on the charging device identifier; and
moving the charging device positioning system to the optimized configuration to maximize a charging rate of the mobile device.

11. The wireless charging system of claim 9, wherein the motor is in communication with a charging system controller having data processing hardware and memory hardware storing instructions that, when executed by the data processing hardware, cause the data processing hardware to perform operations comprising:
receiving charging rate feedback from the wireless charging module indicating a current charging rate for a charging;
determining whether the current charge rate satisfies a charge rate threshold; and
when the current charging rate does not satisfy a charge rate threshold, instructing the charging device positioning system to move to an optimized configuration to maximize the current charging rate.

12. A motor vehicle including a wireless charging system for charging a mobile device arranged within a passenger compartment area of a motor vehicle, the wireless charging system comprising:
a wireless charging module providing a wireless charging area having a charging zone;
a charging device positioning system disposed adjacent to the wireless charging module and configured to bias the mobile device into the charging zone; and
a charging system controller having data processing hardware and memory hardware storing instructions that, when executed by the data processing hardware, cause the data processing hardware to perform operations comprising:
receiving at least one of a charging device identifier or a charging rate feedback from the wireless charging module indicating a current charging rate for a charging;
determining an optimized configuration for the charging device positioning system based on the charging device identifier or the charging rate feedback; and
instructing the charging device positioning system to move the charging device positioning system to the optimized configuration to maximize a charging rate of the mobile device.

13. The motor vehicle of claim 12, wherein the wireless charging module is integrated into an interior panel of the passenger compartment area of the motor vehicle.

14. The motor vehicle of claim 13, wherein the charging device positioning system includes a longitudinal positioning system configured to bias the mobile device into the charging zone along a longitudinal axis of the motor vehicle.

15. The motor vehicle of claim 14, wherein the charging device positioning system includes a lateral positioning system configured to bias the mobile device into the charging zone along a lateral axis of the motor vehicle.

16. The motor vehicle of claim 15, wherein at least one of the longitudinal positioning system and the lateral positioning system includes at least one biasing element configured to retract within the interior panel of the passenger compartment area of the motor vehicle.

17. The motor vehicle of claim 16, wherein the at least one biasing element includes:
a pair of longitudinal biasing elements of the longitudinal positioning system; and
a pair of lateral biasing elements of the lateral positioning system.

18. The motor vehicle of claim 17, wherein the pair of longitudinal biasing elements of the longitudinal positioning system are configured to move relative to the pair of lateral biasing elements of the lateral positioning system.

19. The motor vehicle of claim 18, wherein each biasing element of the pair of longitudinal biasing elements of the longitudinal positioning system and each biasing element of the pair of lateral biasing elements of the lateral positioning system is configured to be biased to the charging zone by a spring.

20. The motor vehicle of claim 18, wherein each biasing element of the pair of longitudinal biasing elements of the longitudinal positioning system and each biasing element of the pair of lateral biasing elements of the lateral positioning system is configured to be biased to the charging zone by a motor.
